(19) United States
(12) Patent Application Publication
(10) Pub. No.: US 2024/0121516 A1
(43) Pub. Date: Apr. 11, 2024

(54) SEPARATE EXPOSURE CONTROL FOR PIXEL SENSORS OF AN IMAGE SENSOR

(71) Applicant: QUALCOMM Incorporated, San Diego, CA (US)

(72) Inventors: Zuguang Xiao, San Diego, CA (US); Nan Cui, San Diego, CA (US); Loic Francois Segapelli, San Diego, CA (US)

(21) Appl. No.: 18/045,402

(22) Filed: Oct. 10, 2022

(51) Int. Cl. H04N 23/73; H04N 23/67; H04N 23/72; H04N 25/581; H04N 25/704

(52) U.S. Cl. CPC H04N 23/73; H04N 23/67; H04N 23/72; H04N 25/581; H04N 25/704

(57) ABSTRACT

This disclosure provides systems, methods, and devices for image signal processing that support image processing. In a first aspect, a method of image capture includes determining a first exposure setting for a first array of light sensors of an image sensor; determining a second exposure setting for a second array of light sensors of the image sensor of a different type than the first array; capturing first image data with the first array of light sensors at the first exposure setting; and capturing second image data with the second array of light sensors at the second exposure setting. Other aspects and features are also claimed and described.

### TECHNICAL FIELD

Aspects of the present disclosure relate generally to image processing, and more particularly, to determining settings for capturing an image. Some features may enable and provide improved image processing, including improved exposure control of an image sensor for capturing the image.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

Image capture devices capture a representation of a scene with an image sensor that converts light into electrical signals. The electrical signals may be converted into numerical values that represent the appearance of a scene, such as in a table of values representing a scene with each table entry including a red, green, and blue value indicating a color in a representation of the scene. Capturing the light for conversion to electrical signals is performed by exposing the image sensors to the light for a specified period of time referred to as an exposure setting. A conventional image sensor operates with a single exposure setting such that all portions of the image sensor are exposed to light for the same duration of time.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, an image sensor may include two arrays of sensors including a first array, which may be of a first type of sensor, and a second array, which may be of a second type of sensor. For example, the image sensor may have a sparse phase detection (PD) configuration in which one or more phase detection pixels are co-located with photo pixels. The photo pixels (or the first array of image sensors) are configured for capturing a representation of a scene, and the phase detection pixels (or the second array of image sensors) are configured for capturing aspects of the scene that may be useful for, e.g., focus determinations, exposure determinations, or determination of metadata regarding the scene. In some embodiments, the phase detection sensors are interdigitated within the photo pixel sensors in the image sensor with a fewer number of phase detection sensors than photo sensors. In some embodiments, the output of the phase detection sensors (or the second array of image sensors) is provided to a phase detection autofocus (PDAF) algorithm for controlling a focus point of a camera.

Autofocus is one algorithm that is involved in the capturing of photographs. Autoexposure control (AEC) is also involved in capturing photographs by determining exposure settings for the image sensor. The AEC may determine exposure settings based on statistics extracted from captured image data by filtering the phase detection pixel data from the image data, and determining exposure based on the photo pixel data. In embodiments of this disclosure, the AEC may determine exposure settings for the image sensor based on photo pixel data and/or phase detection (PD) pixel data. Exposure settings for photo pixels and PD pixels may be separately determined. The camera may be configured to capture data using the photo pixels and the PD pixels based on the different exposure settings. Separate control of exposure settings for different types of sensors (e.g., the photo pixel sensors and the PD pixel sensors) may provide better exposure settings for PD pixel sensors, which improves autofocus quality when using PDAF. Separate control of exposure settings for different types of sensors may also provide faster brightness convergence of the photo pixels, which may allow the camera to better adjust to changing scene conditions.

The exposure settings for the phase detection (PD) pixels may be determined by an AEC algorithm to properly expose the PD pixels to improve PDAF quality. The PD pixel data may be excluded when determining the output image frame from the camera, such that the exposure settings for the PD pixels may not negatively affect final image brightness and quality. In some embodiments, separate exposure control of the different image sensor types may be operated continuously. In some embodiments, separate exposure control of the different image sensor types may be triggered based on certain criteria, such as when the scene is determined to have a high dynamic range above a threshold level.

In some embodiments, the exposure setting may be determined by the AEC to intentionally underexpose the PD pixels. Underexposed may refer to a value that is below a saturation level by at least a threshold amount. An overexposed capture may include a certain number of sensors exposed to a maximum intensity and for any scene may include a first range of exposures that results in this saturation condition. A properly exposed capture may be in a second range of exposures below the first range. An underexposed capture may be in a third range of exposures below the second range, wherein the second range and third rang may be threshold amounts different from a saturation level.

Underexposing the PD pixels may allow the AEC to quickly converge on a new exposure setting for the photo pixels after a scene change resulting in a large change in brightness. The underexposed setting, which may be undesirable for photo pixels because of the resulting image having low brightness, may improve the ability to perform exposure determination when scene conditions rapidly change resulting in a rapid or discontinuous increase in brightness that would otherwise saturate the sensor. The AEC may be configurable between different priorities for exposure settings. For example, one configuration may optimize exposure settings for the PD pixels with settings that best expose the PD pixels for the PDAF algorithm. Another configuration may optimize exposure settings to underexpose the PD pixels for use in a saturated scene. These two configurations, and potentially additional configurations, may be toggled between a PD priority setting, which may be a default or higher priority configuration, and a PD underexposed setting.

In one aspect of the disclosure, a method for image processing includes determining a first exposure setting for a first array of light sensors of an image sensor, the first array of light sensors comprising light sensors of a first type; determining a second exposure setting for a second array of light sensors of the image sensor, the second array of light sensors comprising light sensors of a second type different from the first type; capturing first image data with the first array of light sensors at the first exposure setting; and capturing second image data with the second array of light sensors at the second exposure setting.

The method may allow operating the second array of light sensors, which may be phase detection pixels, in an underexposed setting to improve operation of the image capturing device to allow quickly resolving a saturation condition of the first array of light sensors, which may be photo pixels. For example, in some aspects of the disclosure, the method may further include determining an underexposed setting for the second array of light sensors, capturing third image data from the second array of light sensors at the second exposure setting that is the underexposed setting, and determining a third exposure setting for the first array of light sensors based on the third image data. Determining exposure for the first array based on the image data captured by the phase detection pixels at the underexposed setting may allow the automatic exposure control (AEC) for the first array to more quickly resolve from saturation. In some aspects, this exposure control may continue until the exposure settings for the photo pixels are no longer in a certain condition, such as a state of saturation. The method may thus include, according to some aspects, determining new exposure settings for the first array of light sensors that are underexposed, and when a predetermined criteria is met during the determining of the new exposure settings: capturing fourth image data from the second array of light sensors; and determining a focus setting for the image sensor based on the fourth image data.

In an additional aspect of the disclosure, an apparatus includes at least one processor and a memory coupled to the at least one processor. The at least one processor is configured to perform operations including determining a first exposure setting for a first array of light sensors of an image sensor, the first array of light sensors comprising light sensors of a first type; determining a second exposure setting for a second array of light sensors of the image sensor, the second array of light sensors comprising light sensors of a second type different from the first type; capturing first image data with the first array of light sensors at the first exposure setting; and capturing second image data with the second array of light sensors at the second exposure setting.

In an additional aspect of the disclosure, an apparatus includes means for determining a first exposure setting for a first array of light sensors of an image sensor, the first array of light sensors comprising light sensors of a first type; means for determining a second exposure setting for a second array of light sensors of the image sensor, the second array of light sensors comprising light sensors of a second type different from the first type; means for capturing first image data with the first array of light sensors at the first exposure setting; and means for capturing second image data with the second array of light sensors at the second exposure setting.

In an additional aspect of the disclosure, a non-transitory computer-readable medium stores instructions that, when executed by a processor, cause the processor to perform operations. The operations include determining a first exposure setting for a first array of light sensors of an image sensor, the first array of light sensors comprising light sensors of a first type; determining a second exposure setting for a second array of light sensors of the image sensor, the second array of light sensors comprising light sensors of a second type different from the first type; capturing first image data with the first array of light sensors at the first exposure setting; and capturing second image data with the second array of light sensors at the second exposure setting.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2A is a block diagram illustrating an example data flow path for image data processing in an image capture device according to one or more embodiments of the disclosure.

FIG. 2B is a block diagram illustrating an example image sensor with two arrays of pixel sensors according to one or more embodiments of the disclosure.

FIG. 2C is a block diagram illustrating data flow between a processor and an image sensor with two arrays of pixel sensors according to one or more embodiments of the disclosure.

FIG. 3 shows a flow chart of an example method for processing image data to determine separate exposure settings for different arrays of pixels sensors in an image sensor according to some embodiments of the disclosure.

FIG. 4 is a block diagram illustrating an example processor configuration for image data processing in an image capture device according to one or more embodiments of the disclosure.

FIG. 5 is block diagram illustrating an example method for changing exposure calculation parameters for different arrays of pixel sensors in an image sensor according to one or more embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for image capture and/or image processing, in which exposure settings are separately determined for photo pixels and PD pixels. The image capture operation may include determining a first exposure setting for a first array of light sensors of an image sensor; determining a second exposure setting for a second array of light sensors of the image sensor; capturing first image data with the first array of light sensors at the first exposure setting; and capturing second image data with the second array of light sensors at the second exposure setting.

Particular implementations of the subject matter described in this disclosure may be implemented to realize one or more of the following potential advantages or benefits. In some aspects, the present disclosure provides techniques for improved image quality and image capture operation by separately determining exposure settings for photo pixels and PD pixels. Separate control of exposure settings for different types of sensors (e.g., the photo pixels sensors and the phase detection sensors) may provide better exposure for PD pixels, which improves autofocus quality when using the PDAF sensors. Separate control of exposure settings for different types of sensors may also provide faster brightness convergence of the photo pixels, which may allow the camera to better adjust to changing scene conditions.

An example device for capturing image frames using one or more image sensors, such as a smartphone, may include a configuration of one, two, three, four, or more cameras on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames in a memory and/or otherwise provide the output image frames to processing circuitry (such as through a bus). The processing circuitry may perform further processing, such as for encoding, storage, transmission, or other manipulation of the output image frames.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

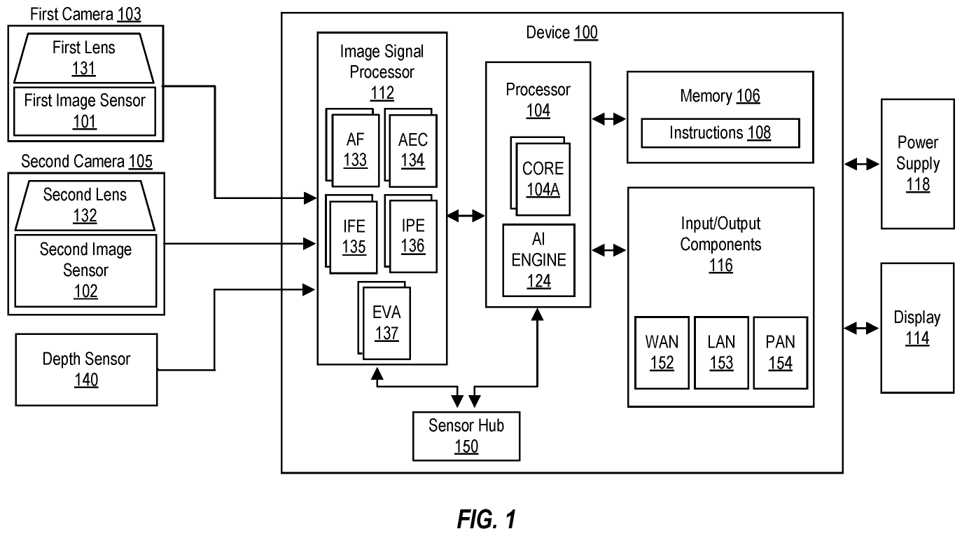

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons.

I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands.

The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first camera 103 and second camera 105, respectively. In another embodiment, a wire interface couples the image signal processor 112 to an external image sensor. In a further embodiment, a wireless interface couples the image signal processor 112 to the image sensor 101, 102.

The first camera 103 may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The camera 103 may be a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. The camera 103 may have different characteristics based on the current aperture size, such as a different depth of focus (DOF) at different aperture sizes.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112, and output from the depth sensors are processed in a similar manner to that of image sensors 101 and 102. Example depth sensors include active sensors, including one or more of indirect Time of Flight (iToF), direct Time of Flight (dToF), light detection and ranging (Lidar), mmWave, radio detection and ranging (Radar), and/or hybrid depth sensors, such as structured light. In embodiments without a depth sensor 140, similar information regarding depth of objects or a depth map may be generated in a passive manner from the disparity between two image sensors (e.g., using depth-from-disparity or depth-from-stereo), phase detection auto-focus (PDAF) sensors, or the like. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), one or more auto exposure compensation (AEC) 134 engines, and/or one or more engines for video analytics (EVAs). The AF 133, AEC 134, IFE 135, IPE 136, and EVA 137 may each include application-specific circuitry, be embodied as software code executed by the ISP 112, and/or a combination of hardware and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system-on-chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including exposure determination operations for different portions of an image sensor. For example, execution of the instructions can instruct the image signal processor 112 to begin or end capturing an image frame or a sequence of image frames, in which the capture includes autofocus using focus parameters based on image data captured at an exposure level specific to the phase detection pixel sensors as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, a camera application executing on processor 104 may receive a user command to begin a video preview display upon which a video comprising a sequence of image frames is captured and processed from one or more image sensors 101 or 102 through the image signal processor 112. Image processing to generate “output” or “corrected” image frames, such as according to techniques described herein, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 or other co-processor) to offload certain tasks from the cores 104A. The AI engine 124 may be used to offload tasks related to, for example, face detection and/or object recognition. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

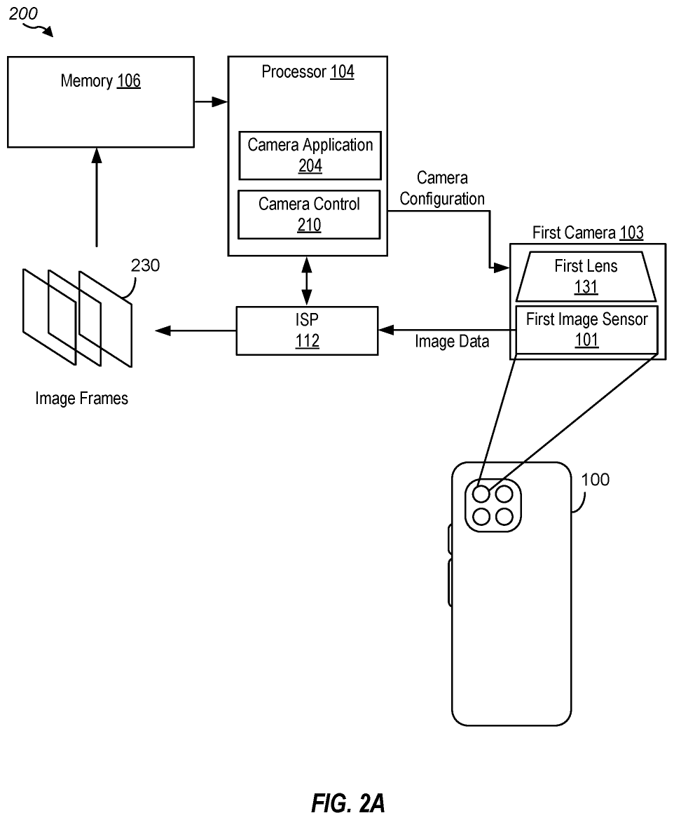

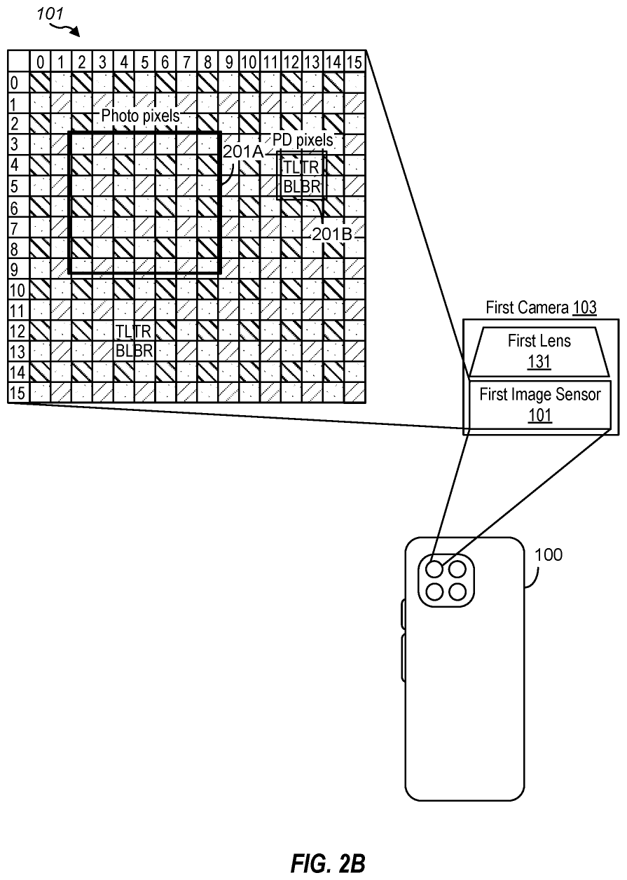

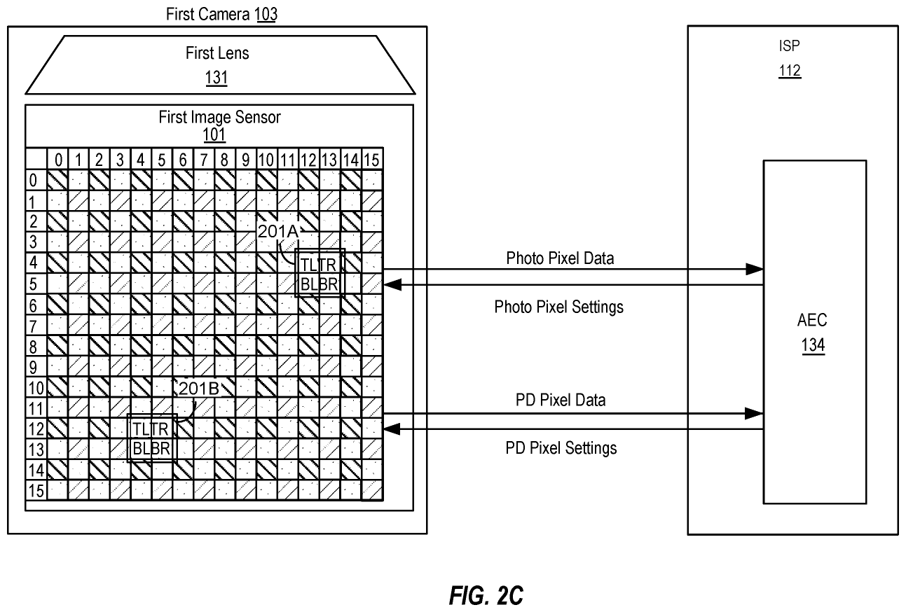

The exemplary image capture device of FIG. 1 may be operated to obtain improved images by obtaining better exposure settings and/or focus positions for photographs by separately controlling first exposure settings for a first array of a sensor of a first type in an image sensor and second exposure settings for a second array of a sensor of a second type in the image sensor. One example method of operating one or more cameras, such as camera 103, is shown in FIG. 2A and described below.

FIG. 2A is a block diagram illustrating an example data flow path for image data processing in an image capture device according to one or more embodiments of the disclosure. A processor 104 of system 200 may communicate with image signal processor (ISP) 112 through a bi-directional bus and/or separate control and data lines. The processor 104 may control camera 103 through camera control 210, such as for configuring the camera 103 through a driver executing on the processor 104. The camera control 210 may be managed by a camera application 204 executing on the processor 104. The camera application 204 may provide a settings menu accessible to a user such that a user can specify individual camera settings or select a profile with corresponding camera settings. The camera application 204 may also or alternatively automatically determine camera settings without user input. The camera control 210 communicates with the camera 103 to configure the camera 103 in accordance with commands received from the camera application 204. The camera application 204 may be, for example, a photography application, a document scanning application, a messaging application, or other application that processes image data acquired from camera 103.

The camera configuration may include parameters that specify, for example, a frame rate, an image resolution, a readout duration, an exposure level, an aspect ratio, and/or an aperture size. The camera 103 may obtain image data while configured with the camera configuration. For example, the processor 104 may execute a camera application 204 to instruct camera 103, through camera control 210, to set a first camera configuration for the camera 103, to obtain first image data from the camera 103 operating in the first camera configuration, to instruct camera 103 to set a second camera configuration for the camera 103, and to obtain second image data from the camera 103 operating in the second camera configuration.

In some embodiments in which camera 103 is a variable aperture (VA) camera system, the processor 104 may execute a camera application 204 to instruct camera 103 to configure to a first aperture size, obtain first image data from the camera 103, instruct camera 103 to configure to a second aperture size, and obtain second image data from the camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 is a larger aperture size than f/8.0.

The image data received from camera 103 may be processed in one or more blocks of the ISP 112 to form image frames 230 that are stored in memory 106 and/or provided to the processor 104. The processor 104 may further process the image data to apply effects to the image frames 230. Effects may include Bokeh, lighting, color casting, and/or high dynamic range (HDR) merging. In some embodiments, functionality may be embedded in a different component, such as the ISP 112, a DSP, an ASIC, or other custom logic circuit for performing the additional image processing.

An example image sensor 101 for an image capture is shown in more detail in FIG. 2B. FIG. 2B is a block diagram illustrating an example image sensor with two arrays of pixel sensors according to one or more embodiments of the disclosure. The image sensor 101 may include a first array of sensors including photo pixels 201A and a second array of sensors including phase detection (PD) pixels 201B. In the shown embodiment, the pixels may be organized with color filters in a Bayer pattern, however other color organizations may be implemented, including monochrome configurations. Also, the pixels of FIG. 2B show PD pixels 201B interspersed among photo pixels 201A. The arrangement of the two arrays of pixels may have other configurations. For example, the PD pixels may be grouped together at one location in the image sensor 101, such as a corner edge or a center.

An example data flow between an image sensor 101 with two arrays of pixel sensors, such as the image sensor 101 of FIG. 2B, is shown in FIG. 2C. FIG. 2C is a block diagram illustrating data flow between a processor and an image sensor with two arrays of pixel sensors according to one or more embodiments of the disclosure. The ISP 112 may perform communications related to the photo pixels 201A separate from the PD pixels 201B. Although communications are illustrated with different arrows, the communications may be carried out over the same channel or bus, such as by transmitting one or more commands related to the photo pixels 201A over the bus followed by the transmitting of one or more commands related to the PD pixels 201B over the same bus in a time-multiplexed manner. In another example, a single command may be transmitted to the image sensor 101 to configure the photo pixels 201A and the PD pixels 201B. The photo pixel settings may be configured with the best exposure setting to expose the frame for improving image quality to a user. The PD pixel settings may be configured with the best exposure setting to expose the PD pixels only. In some embodiments, the use of different exposure settings may be triggered by certain conditions, such as determining the scene has a high dynamic range (e.g., a dynamic range above a threshold value) and/or determining the image sensor supports only a single exposure mode of operation. When different exposure settings are not triggered, the exposure settings for the two groups of pixels may be the same exposure settings.

One example configuration for controlling different exposure settings may be based on criteria involving the brightness of the image data captured from the photo pixels. For example, the ISP 112 may determine, based on previous photo pixel data, whether the photo pixels are exposed above a threshold level, in which the threshold level corresponds to a saturation level or within a threshold amount of the saturation level. When the first array of light sensors is not exposed above the threshold level, the ISP 112 may determine the first exposure setting based on the photo pixel data and separately determining the second exposure setting also based on the photo pixel data. The same or different parameters may be applied to the photo pixel data to determine the first and second exposure settings. When the photo pixels are not exposed above the threshold level such that the photo pixels are not near saturation, the ISP 112 may determine the first exposure setting for the photo pixels based on the photo pixel data and determine the second exposure setting for the PD pixels based on the PD pixel data.

The camera configuration of FIG. 2A may include information for configuring exposure settings for photo pixels 201A and PD pixels 201B. This camera configuration may be transmitted by the processor 104, the ISP 112, the ISP 112 under control of the processor 104, or other logic circuitry. In some embodiments, the automatic exposure control (AEC) 134 may receive the photo pixel data and PD pixel data or information regarding the respective pixel data. The AEC 134 may determine separate exposure settings for the photo pixels 201A and PD pixels 201B, and transmit photo pixel settings and PD pixel settings to the image sensor 101.

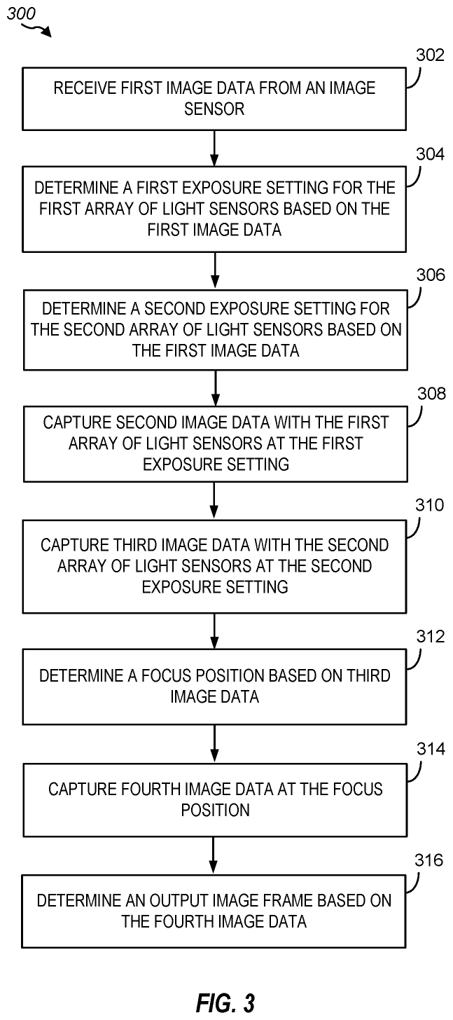

The system 200 of the various embodiments of FIGS. 2A-2C may be configured to perform the operations described with reference to FIG. 3 to determine output image frames 230. FIG. 3 shows a flow chart of an example method for processing image data to determine separate exposure settings for different arrays of pixels sensors in an image sensor according to some embodiments of the disclosure. The capturing in FIG. 3 may obtain an improved digital representation of a scene, which results in a photograph or video with higher image quality (IQ).

At block 302, first image data is received from the image sensor, such as while the image sensor is configured with the camera configuration. The first image data may be received at ISP 112, processed through an image front end (IFE), an engine for video analytics (EVA), and/or an image post-processing engine (IPE) of the ISP 112, and/or other processor 104, and stored in memory. In some embodiments, the capture of image data may be initiated by a camera application executing on the processor 104, which causes camera control 210 to activate capture of image data by the camera 103, and cause the image data to be supplied to a processor, such as processor 104 or ISP 112. The first image data may include image data from a first array of light sensors (e.g., photo pixels) and/or a second array of light sensors (e.g., phase detection (PD) pixels).

Exposure settings may be determined separately for the different arrays of the image sensor. At block 304, a first exposure setting is determined for the first array of light sensors based on the first image data. At block 306, a second exposure setting is determined for the second array of light sensors based on the first image data. The determined exposure settings may be configured on the image sensor. The first and second exposure settings may be determined based, in part, on an average brightness of a portion of the first image data. For example, the first exposure setting may be based on a first portion of the first image data, which may be data received from the first array of photo pixels. Likewise, the second exposure setting may be based on a second portion of the first image data, which may be data received from the second array of photo pixels. In some embodiments, the first and second exposure settings may be based on image statistics of the first portion and the second portion, respectively, of the first image data, in which the statistics may be determined by a EVA of the ISP 112.

Image data may be captured by the image sensor with the two or more different exposure settings through the two or more arrays of pixel sensors. At block 308, second image data may be captured with the first array of pixel sensors at the first exposure setting. At block 310, third image data may be captured with the second array of pixel sensors at the second exposure setting.

At block 312, a focus position for the image sensor may be determined. The focus position may be configured through, for example, a command to set a lens position of a lens corresponding to the image sensor. The focus position may be determined by an autofocus (AF) algorithm using information from the phase detection (PD) pixel sensors as part of a phase-detection auto focus (PDAF) system. In some embodiments, the phase detection information may be augmented by other information, such as object detection or other ranging technique.

The focus position determined at block 312 may be more accurate and/or achieved in a shorter amount of time by using data captured from the second array of pixel sensors (e.g., PD pixel sensors) because the PD pixel sensors may have a different exposure setting than the photo pixel sensors from which focus information may alternatively be derived. With the focus and exposure determined for a scene, a representation of the scene may be captured from the photo pixel sensors for one or more output image frames. At block 314, fourth image data may be captured at the focus position including data from the photo pixels. At block 316, output image frames are determined based on the fourth image data include the from the photo pixels, but excluding the PD pixel data. Image frames 230 may be determined by the processor 104 and/or ISP 112 and stored in memory 106. The stored image frames may be read by the processor 104 and used to form a preview display on a display of the device 100 and/or processed to form a photograph for storage in memory 106 and/or transmission to another device.

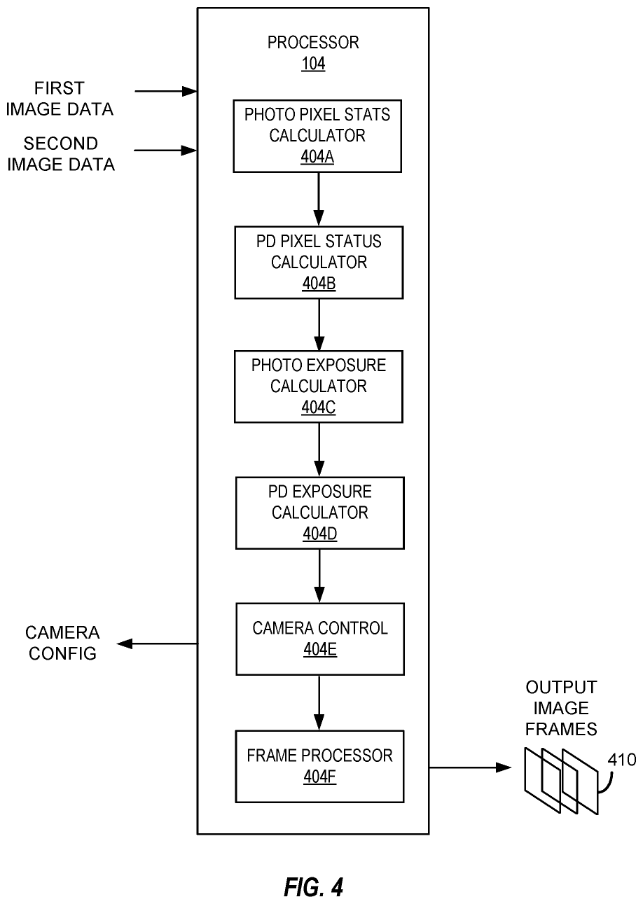

FIG. 4 is a block diagram illustrating an example processor configuration for image data processing in an image capture device according to one or more embodiments of the disclosure. The processor 104, and/or other processing circuitry, may be configured to operate on image data to perform one or more operations of the method of FIG. 3. The image data may be processed to determine one or more output image frames 410. The processor 104 may be a single die comprising logic and memory circuits for each of the modules shown in FIG. 4.

Block 404A is a photo pixel statistics calculator. The calculator 404A may process first image data received from the first array of pixels of a first type of the image sensor. The statistics may include, for example, an average brightness level of pixels in the first image data.

Block 404B is a phase detection (PD) pixel statistics calculator. The calculator 404B may process second image data received from the second array of pixels of a second type of the image sensor. The statistics may include, for example, an average brightness level of pixels in the second image data.

Although blocks 404A-B are shown as two different calculators, the processor 104 may be configured with a single calculator that calculates statistics for image data, and that single calculator is provided with first image data and second image data separately to determine a first statistic and a second statistic. For example, an engine for video analytics (EVA) of the processor 104 may be used to determine the first statistic from the first image data and the second statistic from the second image data.

Block 404C is a photo exposure calculator that determines exposure settings for the first array of pixels based on the first image data from the phase detection pixels and/or the second image data from the photo pixels. In some embodiments, the exposure settings may also be determined based on other information, such as the detection of a scene change, motion sensor information (such as accelerometer, gyroscope, or magnetometer data indicating a rapid movement of the image capture device that indicates a scene change), and/or criteria applied to the first image data or the second image data. Example criteria may include a first threshold applied to a characteristic of the first image data and/or a second threshold applied to a characteristic of the second image data.

Block 404D is a phase detection (PD) exposure calculator that determines exposure settings for the second array of pixels based on the first image data from the phase detection pixels and/or the second image data from the photo pixels. In some embodiments, the exposure settings may also be determined based on other information, such as the detection of a scene change, motion sensor information (such as accelerometer, gyroscope, or magnetometer data indicating a rapid movement of the image capture device that indicates a scene change), and/or criteria applied to the first image data or the second image data. Example criteria may include a first threshold applied to a characteristic of the first image data and/or a second threshold applied to a characteristic of the second image data.

Block 404E is a camera control module. The camera control 404E may receive the photo pixel exposure setting from calculator 404C and the phase detection pixel exposure setting from calculator 404D. The camera control 404E may use the exposure settings and/or other data to determine a camera configuration for transmission to the camera to configure, for example, separate exposure settings for two arrays of different types of pixel sensors in an image sensor of the camera.

Block 404F is a frame processor module. The frame processor 404F may receive image data, such as image data from photo pixels of the image sensor and determine output image frames 410 containing a representation of the scene in the view of the camera. The frame processor 404F may perform operations including, for example, cropping the image data by discarding boundary pixels, applying electronic image stabilization (EIS) or digital image stabilization (DIS), applying motion compensation, combining pixels of the second image data as part of a high dynamic range (HDR) merge, and/or applying lighting effects such as portrait effects.

Although the blocks 404A-F are shown as part of one processor, the blocks may be incorporated into two or more different processors located on a single or multiple dies. For example, the statistics calculators 404A-B may be part of IPE 136 in ISP 112 and exposure calculators 404C-D may be part of AEC 134 in ISP 112.

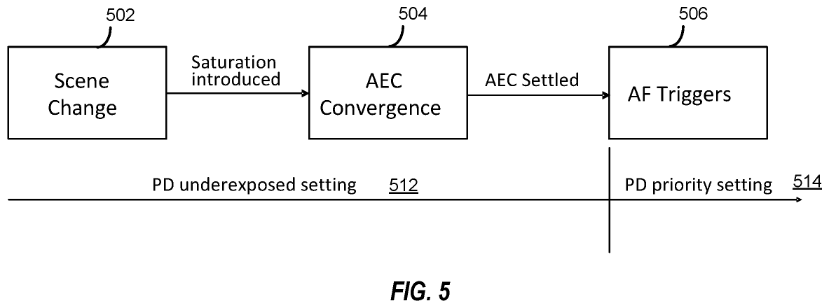

Priorities for the exposure determination of the photo pixels and/or the phase detection pixels may be adjusted within the photo pixel exposure calculator 404C and/or PD exposure calculator 404D. In some embodiments, the priorities may be adjusted based on a detected scene change. FIG. 5 is block diagram illustrating an example method for changing exposure calculation parameters for different arrays of pixel sensors in an image sensor according to one or more embodiments of the disclosure. A scene change occurs at block 502. The scene change may be detected based on determining a brightness change from one frame to another frame exceeds a threshold amount, a brightness change of previous pixel data and current data exceeds a threshold amount, accelerometer data indicates motion exceeds a threshold amount, global positioning data indicates motion exceeds a threshold amount, motion vector information from one frame to another frame exceeds a threshold amount, and/or other predetermined criteria that may be configured on the image capture device. The scene change may cause saturation of either or both of the PD pixels or the photo pixels of the image sensor. Thus, when a scene change is detected, one or more parameters of the PD exposure setting calculator 404D may be adjusted to prioritize underexposure of the PD pixels, which can speed up the exposure calculations and/or focus position determination.

After the scene change at block 502, AEC convergence proceeds at block 504. During AEC convergence, the exposure calculator determines exposure settings that progress the exposure settings towards an optimal exposure setting. The optimal exposure setting in a first configuration may be determined by the PD underexposed setting 512, in which the optimal exposure setting is an underexposed value that provides sufficient scene information while also providing sufficient headroom at the image sensor to reduce the likelihood of overexposure with a rapid brightness increase. The AEC convergence at block 504 may determine a criteria is reached that indicates the exposure settings have converged on the optimum settings (e.g., a cost function result is reduced to less than a threshold value) based on parameters associated with the PD underexposed setting 512. When the AEC is settled, autofocus (AF) triggers at block 506 may be activated. At block 506, the autofocus (AF) algorithm may determine a focal position for capturing the photo pixels that form a representation of the scene. During operation of the AF algorithm, the exposure calculator 404D is configured with parameters associated with a PD priority setting 514. The PD priority setting 514 configures the AEC algorithm for optimizing exposure settings to improve effectiveness of the AF algorithm. The optimized AEC operation based on setting 514 may result in improved autofocus, although less headroom may be available to prevent oversaturation of the PD pixels upon a scene change to a scene with increased brightness.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to perform operations including determining a first exposure setting for a first array of light sensors of an image sensor, the first array of light sensors comprising light sensors of a first type; determining a second exposure setting for a second array of light sensors of the image sensor, the second array of light sensors comprising light sensors of a second type different from the first type; capturing first image data with the first array of light sensors at the first exposure setting; and capturing second image data with the second array of light sensors at the second exposure setting.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the apparatus is further configured to receive previous image data, wherein: determining the first exposure setting comprises determining first image statistics of a first portion of the previous image data corresponding to the first array of light sensors, wherein the first exposure setting is based on the first image statistics; and determining the second exposure setting comprises determining second image statistics of a second portion of the previous image data corresponding to the second array of light sensors, wherein the second exposure setting is based on the second image statistics.

In a third aspect, in combination with one or more of the first aspect or the second aspect, determining the first exposure setting comprises determining an exposure setting for photo pixels of the image sensor, and determining the second exposure setting comprises determining an exposure setting for phase detection pixels of the image sensor.

In a fourth aspect, in combination with one or more of the first aspect through the third aspect, determining the first exposure setting comprises determining an exposure setting for capturing a representation of a scene, and determining the second exposure setting comprises determining an exposure setting for capturing autofocus information.

In a fifth aspect, in combination with one or more of the first aspect through the fourth aspect, capturing the second image data with the second array of light sensors at the second exposure setting comprises capturing underexposed image data at an underexposed exposure setting, with the processor further configured to perform operations including determining a third exposure setting for the first array of light sensors of the image sensor based on the second image data.

In a sixth aspect, in combination with one or more of the first aspect through the fifth aspect, the processor is further configured to perform operations including determining a focus position based on the second image data; capturing third image data with the first array of light sensors at the focus position; and determining an output image frame based on the third image data.

In a seventh aspect, in combination with one or more of the first aspect through the sixth aspect, the processor is further configured to perform operations including receiving previous image data comprising previous photo pixel data from the first array of light sensors of the image sensor and previous phase detection pixel data from the second array of light sensors of the image sensor, wherein: determining, based on the previous photo pixel data, whether the first array of light sensors is exposed above a threshold level, wherein the threshold level corresponds to a saturation value for the first array of light sensors; when the first array of light sensors is not exposed above the threshold level: determining the first exposure setting based on the first image data; and determining the second exposure setting based on the first image data; and when the second array of light sensors is not exposed above the threshold level: determining the first exposure setting based on the first image data; and determining the second exposure setting based on the second image data.

In an eighth aspect, in combination with one or more of the first aspect through the seventh aspect, the processor is further configured to perform operations including determining a scene change for the image sensor before determining the second exposure setting, wherein determining the second exposure setting for the second array of light sensors comprises determining an exposure setting based on determining the scene change.

In a ninth aspect, in combination with one or more of the first aspect through the eighth aspect, determining the first exposure setting comprises determining an exposure setting for photo pixels of the image sensor, and determining the second exposure setting comprises determining an exposure setting for phase detection pixels of the image sensor.

In a tenth aspect, in combination with one or more of the first aspect through the ninth aspect, the processor is further configured to perform operations including determining a focus position based on the second image data; capturing third image data with the first array of light sensors at the focus position; and determining an output image frame based on the third image data.

In an eleventh aspect, in combination with one or more of the first aspect through the tenth aspect, determining the second exposure setting for the second array of light sensors comprises determining an underexposed setting for the second array of light sensors, and the processor is further configured for capturing third image data from the second array of light sensors at the second exposure setting; and determining a third exposure setting for the first array of light sensors based on the third image data.

In a twelfth aspect, in combination with one or more of the first aspect through the eleventh aspect, the processor is further configured for determining new exposure settings for the first array of light sensors that are underexposed; and, when a predetermined criteria is met during the determining of the new exposure settings, capturing fourth image data from the second array of light sensors, and determining a focus setting for the image sensor based on the fourth image data.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-5 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4 and 5 may be combined with one or more blocks (or operations) described with reference to another of the figures. For example, one or more blocks (or operations) of FIG. 4 may be combined with one or more blocks (or operations) of FIGS. 1-3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method, comprising:
determining a first exposure setting for a first array of light sensors of an image sensor, the first array of light sensors comprising photo pixels;
determining a second exposure setting for a second array of light sensors of the image sensor, the second array of light sensors comprising phase detection pixels;
capturing first image data with the first array of light sensors at the first exposure setting; and
capturing second image data with the second array of light sensors at the second exposure setting.

2. The method of claim 1, further comprising:
receiving previous image data,
wherein:
determining the first exposure setting comprises determining first image statistics of a first portion of the previous image data corresponding to the first array of light sensors, wherein the first exposure setting is based on the first image statistics; and
determining the second exposure setting comprises determining second image statistics of a second portion of the previous image data corresponding to the second array of light sensors, wherein the second exposure setting is based on the second image statistics.

3. The method of claim 1, wherein:
determining the first exposure setting comprises determining an exposure setting for capturing a representation of a scene, and
determining the second exposure setting comprises determining an exposure setting for capturing autofocus information.

4. The method of claim 3, further comprising:
determining a focus position based on the second image data;
capturing third image data with the first array of light sensors at the focus position; and
determining an output image frame based on the third image data.

5. The method of claim 1, wherein:
determining the second exposure setting for the second array of light sensors comprises determining an underexposed setting for the second array of light sensors,
the method further comprising:
capturing third image data from the second array of light sensors at the second exposure setting; and
determining a third exposure setting for the first array of light sensors based on the third image data.

6. The method of claim 5, further comprising:
determining new exposure settings for the first array of light sensors that are underexposed;
when a predetermined criteria is met during the determining of the new exposure settings:
capturing fourth image data from the second array of light sensors; and
determining a focus setting for the image sensor based on the fourth image data.

7. The method of claim 1, further comprising:
receiving previous image data comprising previous photo pixel data from the first array of light sensors of the image sensor and previous phase detection pixel data from the second array of light sensors of the image sensor,
wherein:
determining, based on the previous photo pixel data, whether the first array of light sensors is exposed above a threshold level, wherein the threshold level corresponds to a saturation value for the first array of light sensors;
when the first array of light sensors is not exposed above the threshold level:
determining the first exposure setting based on the first image data; and
determining the second exposure setting based on the first image data; and
when the second array of light sensors is not exposed above the threshold level:
determining the first exposure setting based on the first image data; and
determining the second exposure setting based on the second image data.

8. The method of claim 1, further comprising:
determining a scene change for the image sensor before determining the second exposure setting,
wherein determining the second exposure setting for the second array of light sensors comprises determining an exposure setting based on determining the scene change.

9. The method of claim 1, wherein the second array of light sensors is fewer in number than the first array of light sensors.

10. The method of claim 1, further comprising:
determining a focus position based on the second image data;
capturing third image data with the first array of light sensors at the focus position; and
determining an output image frame based on the third image data.

11. An apparatus, comprising:
a memory storing processor-readable code; and
at least one processor coupled to the memory, the at least one processor configured to execute the processor-readable code to cause the at least one processor to perform operations including:
determining a first exposure setting for a first array of light sensors of an image sensor, the first array of light sensors comprising photo pixels;
determining a second exposure setting for a second array of light sensors of the image sensor, the second array of light sensors comprising phase detection pixels;
capturing first image data with the first array of light sensors at the first exposure setting; and
capturing second image data with the second array of light sensors at the second exposure setting.

12. The apparatus of claim 11, wherein the processor is further configured to perform operations including:
receiving previous image data,
wherein:
determining the first exposure setting comprises determining first image statistics of a first portion of the previous image data corresponding to the first array of light sensors, wherein the first exposure setting is based on the first image statistics; and
determining the second exposure setting comprises determining second image statistics of a second portion of the previous image data corresponding to the second array of light sensors, wherein the second exposure setting is based on the second image statistics.

13. The apparatus of claim 11, wherein:
determining the first exposure setting comprises determining an exposure setting for capturing a representation of a scene, and
determining the second exposure setting comprises determining an exposure setting for capturing autofocus information.

14. The apparatus of claim 13, wherein capturing the second image data with the second array of light sensors at the second exposure setting comprises capturing underexposed image data at an underexposed exposure setting, and
the processor is further configured to perform operations including:
determining a third exposure setting for the first array of light sensors of the image sensor based on the second image data.

15. The apparatus of claim 11, wherein:
determining the second exposure setting for the second array of light sensors comprises determining an underexposed setting for the second array of light sensors, and
the processor further configured to perform operations including:
capturing third image data from the second array of light sensors at the second exposure setting; and
determining a third exposure setting for the first array of light sensors based on the third image data.

16. The apparatus of claim 15, wherein the processor is further configured to perform operations including:
determining new exposure settings for the first array of light sensors that are underexposed;
when a predetermined criteria is met during the determining of the new exposure settings:
capturing fourth image data from the second array of light sensors; and
determining a focus setting for the image sensor based on the fourth image data.

17. The apparatus of claim 11, wherein the processor is further configured to perform operations including:
receiving previous image data comprising previous photo pixel data from the first array of light sensors of the image sensor and previous phase detection pixel data from the second array of light sensors of the image sensor,
wherein:
determining, based on the previous photo pixel data, whether the first array of light sensors is exposed above a threshold level, wherein the threshold level corresponds to a saturation value for the first array of light sensors;
when the first array of light sensors is not exposed above the threshold level:
determining the first exposure setting based on the first image data; and
determining the second exposure setting based on the first image data; and
when the second array of light sensors is not exposed above the threshold level:
determining the first exposure setting based on the first image data; and
determining the second exposure setting based on the second image data.

18. The apparatus of claim 11, wherein the processor is further configured to perform operations including:
determining a scene change for the image sensor before determining the second exposure setting,
wherein determining the second exposure setting for the second array of light sensors comprises determining an exposure setting based on determining the scene change.

19. The apparatus of claim 11, wherein the second array of light sensors is fewer in number than the first array of light sensors.

20. The apparatus of claim 11, wherein the processor is further configured to perform operations including:
determining a focus position based on the second image data;
capturing third image data with the first array of light sensors at the focus position; and
determining an output image frame based on the third image data.

21. A non-transitory computer-readable medium storing instructions that, when executed by a processor, cause the processor to perform operations comprising:
determining a first exposure setting for a first array of light sensors of an image sensor, the first array of light sensors comprising photo pixels;
determining a second exposure setting for a second array of light sensors of the image sensor, the second array of light sensors comprising phase detection pixels;
capturing first image data with the first array of light sensors at the first exposure setting; and
capturing second image data with the second array of light sensors at the second exposure setting.

22. The non-transitory, computer-readable medium of claim 21, wherein the operations further include one or more operations of:
receiving previous image data,
wherein:
determining the first exposure setting comprises determining first image statistics of a first portion of the previous image data corresponding to the first array of light sensors, wherein the first exposure setting is based on the first image statistics; and
determining the second exposure setting comprises determining second image statistics of a second portion of the previous image data corresponding to the second array of light sensors, wherein the second exposure setting is based on the second image statistics.

23. The non-transitory, computer-readable medium of claim 22, wherein:
determining the first exposure setting comprises determining an exposure setting for capturing a representation of a scene, and
determining the second exposure setting comprises determining an exposure setting for capturing autofocus information.

24. The non-transitory, computer-readable medium of claim 21, wherein the operations further include one or more operations of:
receiving previous image data comprising previous photo pixel data from the first array of light sensors of the image sensor and previous phase detection pixel data from the second array of light sensors of the image sensor,
wherein:
determining, based on the previous photo pixel data, whether the first array of light sensors is exposed above a threshold level;
when the first array of light sensors is not exposed above the threshold level:
determining the first exposure setting based on the first image data; and
determining the second exposure setting based on the first image data; and
when the second array of light sensors is not exposed above the threshold level:
determining the first exposure setting based on the first image data; and
determining the second exposure setting based on the second image data.

25. The non-transitory, computer-readable medium of claim 21, wherein the operations further include one or more operations of:
determining a scene change for the image sensor before determining the second exposure setting,
wherein determining the second exposure setting for the second array of light sensors comprises determining an exposure setting based on determining the scene change.

26. An image capture device, comprising:
an image sensor comprising a first array of light sensors and a second array of light sensors, wherein the first array of light sensors comprises photo pixels and the second array of light sensors comprises phase detection (PD) pixels;
a memory storing processor-readable code; and
at least one processor coupled to the memory and to the image sensor, the at least one processor configured to execute the processor-readable code to cause the at least one processor to:
determining a first exposure setting for a first array of light sensors of the image sensor, the first array of light sensors;
determining a second exposure setting for a second array of light sensors of the image sensor;
capturing first image data with the first array of light sensors at the first exposure setting; and
capturing second image data with the second array of light sensors at the second exposure setting.

27. The image capture device of claim 26, wherein the processor is further configured to perform operations including:
receiving previous image data,
wherein:
determining the first exposure setting comprises determining first image statistics of a first portion of the previous image data corresponding to the first array of light sensors, wherein the first exposure setting is based on the first image statistics; and
determining the second exposure setting comprises determining second image statistics of a second portion of the previous image data corresponding to the second array of light sensors, wherein the second exposure setting is based on the second image statistics.

28. The image capture device of claim 27, wherein:
determining the first exposure setting comprises determining an exposure setting for capturing a representation of a scene, and
determining the second exposure setting comprises determining an exposure setting for capturing autofocus information.

29. The image capture device of claim 26, wherein the processor is further configured to perform operations including:
receiving previous image data comprising previous photo pixel data from the first array of light sensors of the image sensor and previous phase detection pixel data from the second array of light sensors of the image sensor,
wherein:
determining, based on the previous photo pixel data, whether the first array of light sensors is exposed above a threshold level;
when the first array of light sensors is not exposed above the threshold level:
determining the first exposure setting based on the first image data; and
determining the second exposure setting based on the first image data; and
when the second array of light sensors is not exposed above the threshold level:
determining the first exposure setting based on the first image data; and
determining the second exposure setting based on the second image data.

30. The image capture device of claim 26, wherein the processor is further configured to perform operations including:
determining a scene change for the image sensor before determining the second exposure setting,
wherein determining the second exposure setting for the second array of light sensors comprises determining an exposure setting based on determining the scene change.
